(19) United States
(12) Patent Application Publication
(10) Pub. No.: US 2011/0174442 A1
(43) Pub. Date: Jul. 21, 2011

(54) BONDING APPARATUS

(75) Inventor: Yoshihisa KAJII, Kanazawa-Shi (JP)

(73) Assignee: Shibuya Kogyo Co. Ltd., Kanazawa-Shi (JP)

(21) Appl. No.: 13/009,877

(22) Filed: Jan. 20, 2011

(30) Foreign Application Priority Data
Jan. 21, 2010 (JP) 2010-010818

(51) Int. Cl. B32B 37/00

(52) U.S. Cl. 156/350

(57) ABSTRACT

A bonding apparatus includes: a bonding head having a bonding tool for sucking and holding an electronic part; elevator means lifting up/down the bonding head; a stopper provided to the bonding head; a stopper support that regulates a descending height of the bonding head with engagement with the stopper; distance detection means that detects a distance between the stopper and the stopper support; stopper support elevator means that lifts up/down the stopper support independently from the bonding head; and control means that controls the stopper support elevator means. The control means controls a height of the stopper support so as to keep the distance between the stopper and the stopper support at a predetermined distance by using a signal from the distance detection means until the bump is melted in heating and pressing the electronic part to the substrate.

### CROSS-REFERENCE TO RELATED APPLICATIONS

This application claims priority from Japanese Patent Application No. 2010-010818 filed on Jan. 21, 2010, the entire subject-matter of which is incorporated herein by reference.

### BACKGROUND OF THE INVENTION

1. Field of the Invention

The invention relates to an improvement of a heating and pressing type bonding apparatus, and, in particular, to a bonding apparatus which, in regulating a descending height of a bonding head with a stopper and a stopper support, extends in accordance with thermal expansion of the bonding head so as to correspond to an extension of an interval between a stopper and a stopper support and controls a distance between a substrate and a chip after a bump has been melted.

2. Description of the Related Art

There has been proposed a related-art heating and pressing type bonding apparatus which, when heating an electronic part and pressing the heated electronic part to a substrate, controls a bonding load of a bonding head that is beforehand set while measuring a load applied in bonding with a load cell installed to the bonding head.

However, in the related-art heating and pressing type bonding apparatus, when a bump of a portion to be bonded has been melted, the bump is not last enduring the bonding load from the bonding head and thus the bonding head comes into descending rapidly, so that the melted bump is excessively broken and collapsed. Thus, there occurs a problem that the excessively broken and collapsed bump contacts an adjacent bump so as to short-circuit the adjacent bumps. Accordingly, inferior products may be appeared.

Alternatively, the bonding may be performed with very low bonding load. In this case, the bump is prevented from being excessively broken and collapsed. However, there occurs the problem that the bump may tend not to be deformed to an appropriate and desired extent. Moreover, when there are a plurality of the bumps in the electronic part and there are variations between sizes of the bumps, certain bumps with small size may not contact the substrate. Therefore, in order to avoid such problems, the bonding load needs to be large in some degree when bonding the chip to the substrate. With consideration of such situation, an approach using a stopper and a stopper support has been employed in order to stop the bonding head at a predetermined position. For example, Japanese Patent No. 3475776 discloses a mechanical stopper that contacts a predetermined portion (corresponding to the stopper) of chip suction means for limiting descending of the chip suction means.

Japanese Patent No. 3475776 measures a relative distance between the stopper and the stopper support and controls the distance between the stopper and the stopper support. However, Japanese Patent No. 3475776 is unable to handle a situation in which the stopper moves upward because of the thermal expansion of the chip suction means during the heating thereof and hence the relative distance between the stopper and stopper support becomes larger. That is, it is assumed that 10 micron of the relative distance in the ascent/descent direction of the chip suction means is required for breaking and collapsing the bump to the appropriate and desired extent. If the chip suction means is thermally expanded for 20 micron during the heating thereof, the stopper moves upward by 20 micron because of the 20 micron thermal expansion of the chip suction means. Thus, although the stopper support limits the descending of the chip suction means with contacting the stopper of the chip suction means, the bump is broken and collapsed excessively, to be strict, to the excess extent of 20 micron corresponding to the thermal expansion of the chip suction means.

Currently, as the bump gets smaller and smaller, the distance between the stopper and the stopper support due to the thermal expansion of the bonding head becomes beyond a tolerance. Accordingly, there is a need to control the height of the bonding head more accurately.

### SUMMARY OF THE INVENTION

An object of the invention is to provide a bonding apparatus, in which a stopper is installed to a bonding head, a stopper support supporting the stopper is disposed so as to ascend/descend in an independent manner from the bonding head, and the height of the stopper support is controlled using the detected distance between the stopper and the stopper support, wherein the bonding apparatus detects an increased distance between the stopper and the stopper support due to the thermal expansion of the bonding head heated in heating and pressing the electronic part to the substrate and then adjusts the increased distance between the stopper and the stopper support to a predetermined distance.

According to an aspect of the invention, there is provided a bonding apparatus that is configured to heat and press an electronic part to a substrate via a conductive bump, the bonding apparatus comprising: a bonding head having a bonding tool for sucking and holding the electronic part; elevator means lifting up/down the bonding head; a stopper provided to the bonding head; a stopper support that regulates a descending height of the bonding head with engagement with the stopper; distance detection means that detects a distance between the stopper and the stopper support; stopper support elevator means that lifts up/down the stopper support independently from the bonding head; and control means that controls the stopper support elevator means, wherein the control means controls a height of the stopper support so as to keep the distance between the stopper and the stopper support at a predetermined distance by using a signal from the distance detection means until the bump is melted in heating and pressing the electronic part to the substrate.

In accordance with the invention, the control means of the bonding apparatus controls a height of the stopper support so as to keep the distance between the stopper and the stopper support at a predetermined distance using a signal from the distance detection means until the bump has been melted in heating and pressing the electronic part to the substrate. Accordingly, the bonding apparatus may detect the increased distance between the stopper and the stopper support due to the thermal expansion of the bonding head heated in heating and pressing the electronic part to the substrate and then may adjust the increased distance between them to a predetermined distance.

In this way, it is possible to counteract the thermal expansion of the bonding head until the bump has been melted in heating and pressing the electronic part to the substrate. Further, in heating and pressing the electronic part to the substrate, when the bump of the portion to be bonded has been melted, the bonding head is prevented from descending to a level lower than a predetermined height. Therefore, even when the high level of the bonding load is applied to the bonding head, the bonding head is prevented from descending to the level lower than the predetermined height and in turn excessively breaking and collapsing the melted bump, thereby bonding the electronic part to the substrate with a narrow pitch bump.

BRIEF DESCRIPTION OF THE DRAWINGS

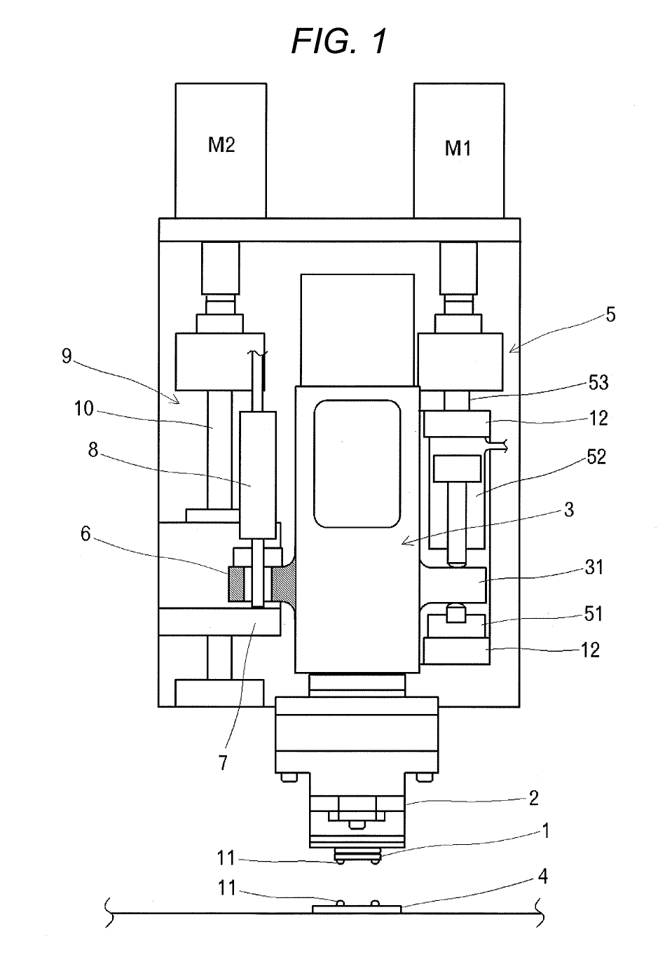

FIG. 1 is a front illustrative view of a flip chip bonding apparatus;

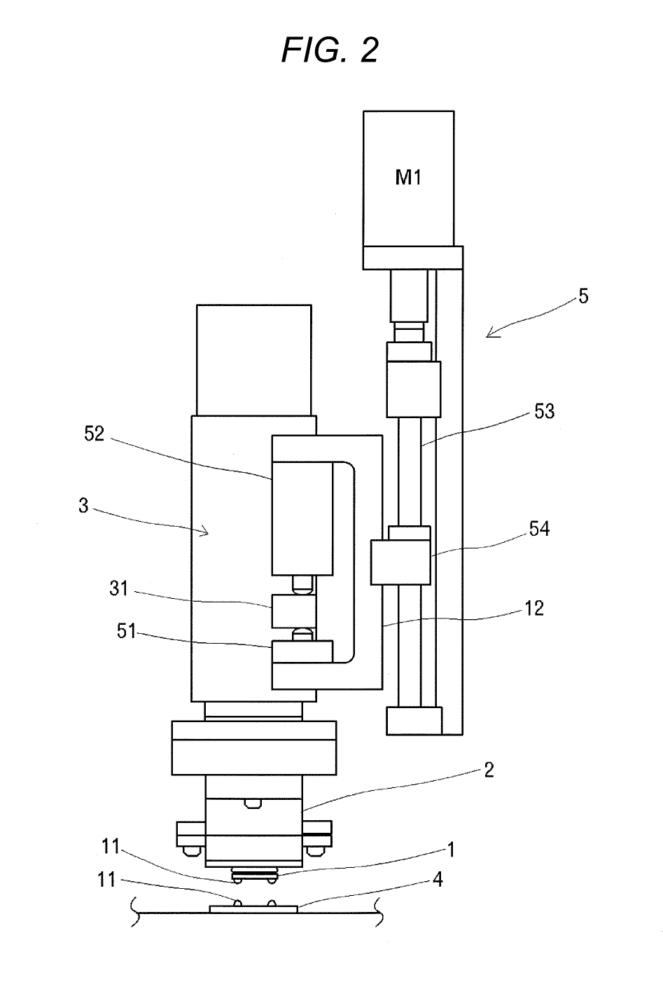

FIG. 2 is a right side illustrative view of the flip chip bonding apparatus;

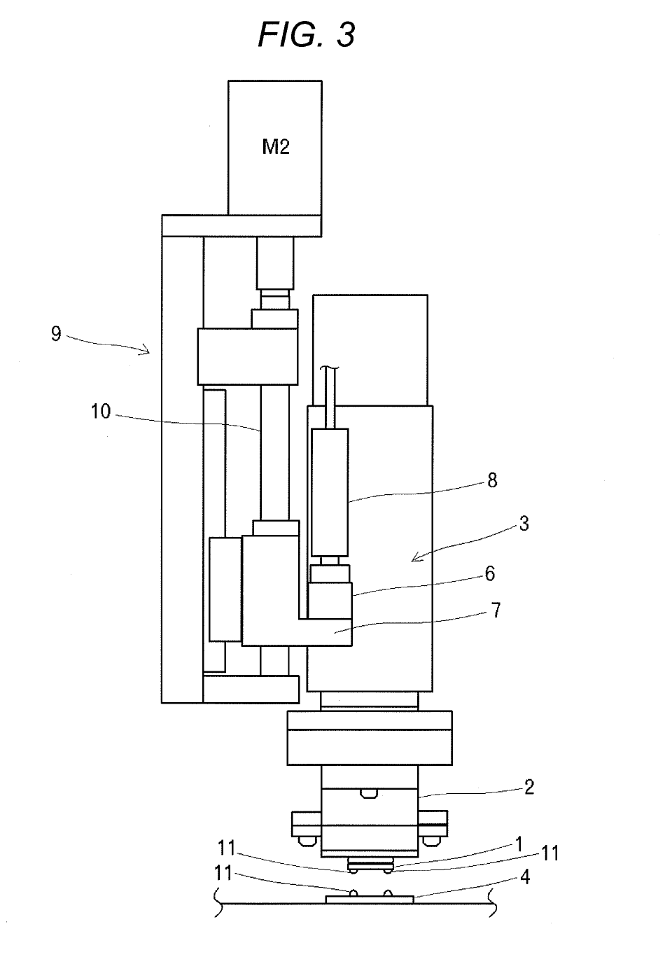

FIG. 3 is a left side illustrative view of the flip chip bonding apparatus;

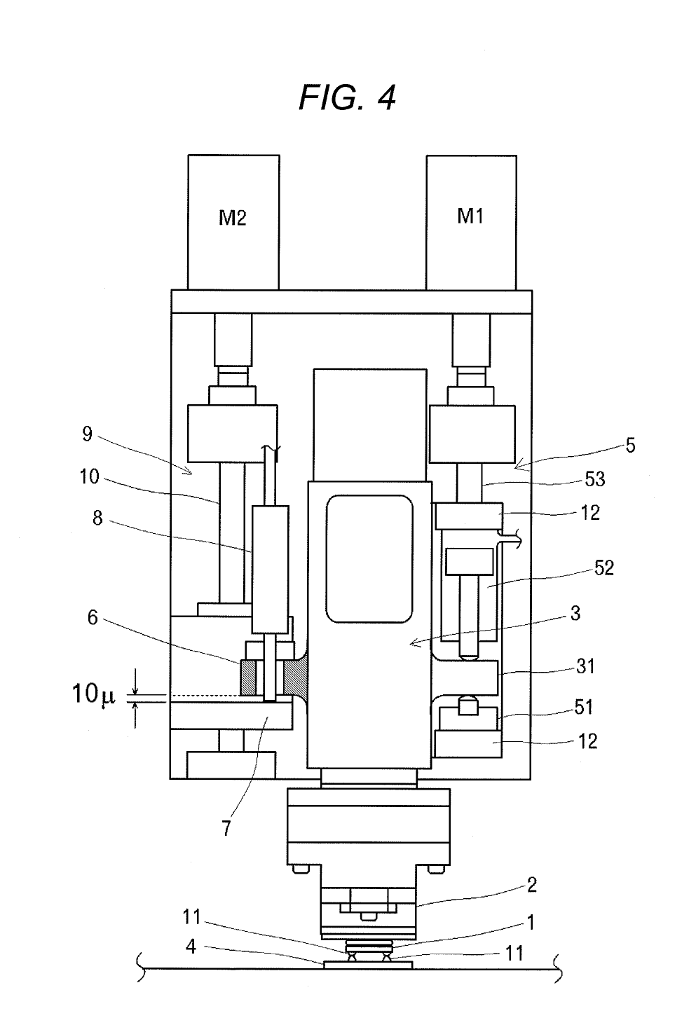

FIG. 4 is a front illustrative view of the flip chip bonding apparatus when a chip and a substrate contact with each other;

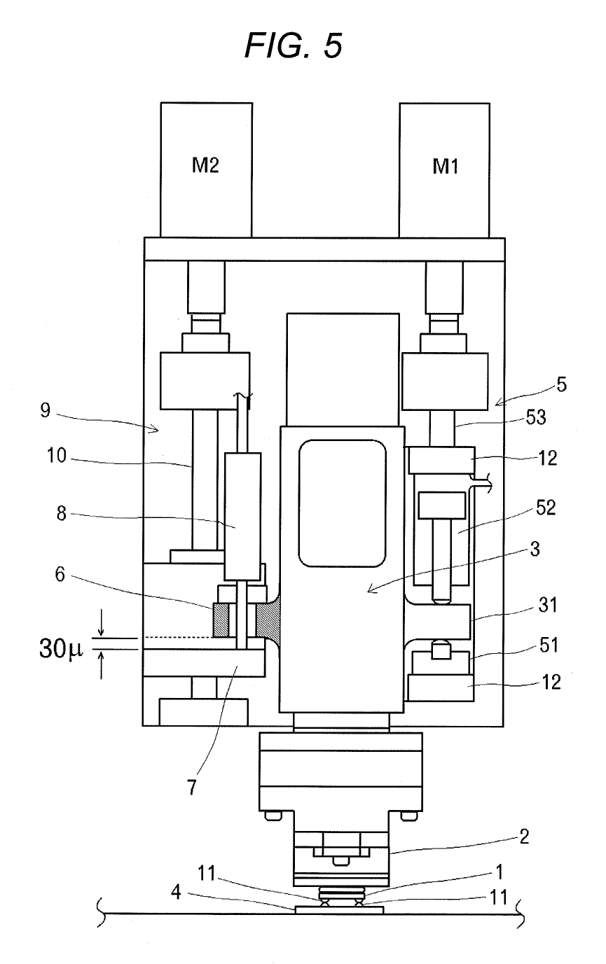

FIG. 5 is a front illustrative view of the flip chip bonding apparatus when the bonding head is thermally expanded;

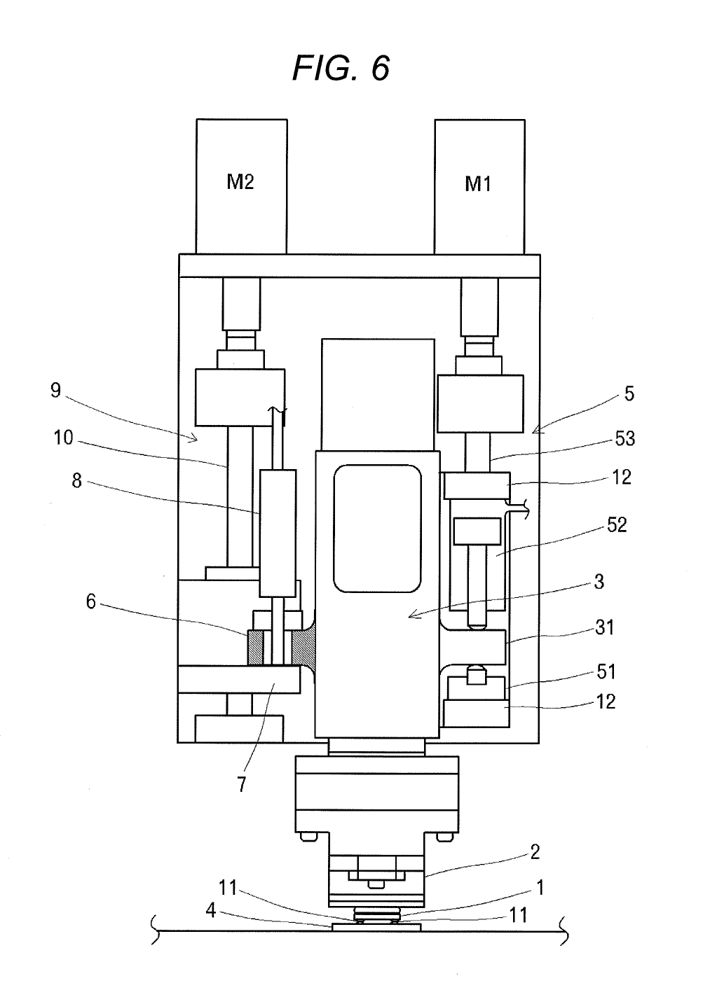

FIG. 6 is a front illustrative view of the flip chip bonding apparatus when the stopper contacts the stopper support; and

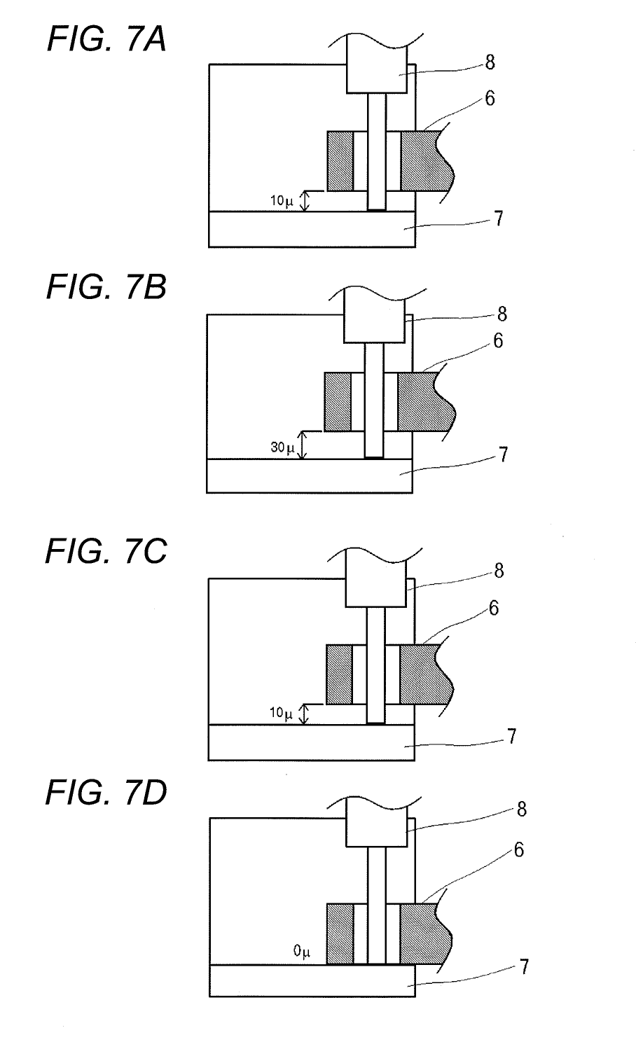

FIGS. 7A-7D are partial views illustrating a relationship between the stopper and the stopper support, in which FIG. 7A is a view illustrating the relationship when the chip and the substrate contact with each other; FIG. 7B is a view illustrating the relationship when the bonding head is thermally expanded; FIG. 7C is a view illustrating the relationship when controlling the distance between the stopper and the stopper support; and FIG. 7D is a view illustrating the relationship when the stopper contacts the stopper support.

### DETAILED DESCRIPTION OF THE PREFERRED EMBODIMENTS

Hereinafter, an exemplary embodiment of the invention will be described with reference to the drawings. The exemplary embodiment is a flip chip bonding apparatus. In the following, the summary of the flip chip bonding apparatus will be described. FIG. 1 is a front illustrative view of a flip chip bonding apparatus, FIG. 2 is a right side illustrative view of the flip chip bonding apparatus and FIG. 3 is a left side illustrative view of the flip chip bonding apparatus.

As shown in FIG. 1 to FIG. 3, the flip chip bonding apparatus includes a bonding head 3, a head elevator unit 5 that lifts up/down the bonding head 3, a stopper 6 installed to the bonding head 3, a stopper support 7 that regulates the descending height of bonding head 3 with engagement with the stopper 6, a displacement meter 8 that includes distance detection means detecting the distance between the stopper 6 and the stopper support 7, and a stopper support elevator unit 9 that lifts up/down the stopper support 7 in an independent manner from the bonding head 3.

The bonding head 3 includes a bonding tool 2, which sucks and holds a semiconductor chip 1 as an electronic part, and incorporates therein a heating unit for heating the bonding tool 2. When the bonding tool 2 is heated, the bonding head 3 itself is thermally expanded.

As shown in FIG. 1 and FIG. 2, the bonding head 3 is mounted onto a base 12 so as to be lifted up/down by a head elevator unit 5. The head elevator unit 5 includes an elevator motor M1 and a head elevator axis 53 rotated by the elevator motor M1. The bonding head 3 is mounted onto the head elevator axis 53 through a nut member 54.

The head elevator unit 5 includes an air cylinder 52, which presses the bonding head 3 downward, and a load cell 51, which supports the bonding head 3 thereon, so as to control the bonding load of the bonding head 3. Specifically, the air cylinder 52 is disposed above a load control protrusion 31, and the load cell 51 is disposed under the load control protrusion 31. The load control protrusion 31 is integrally installed to the bonding head 3. Incidentally, instead of the air cylinder 52, a spring may be used.

The load control is performed as follows. First, until the semiconductor chip 1, which is sucked and held by the bonding tool 2, contacts the substrate 4, the load cell 51 detects as a load the sum of the load due to weight of the bonding head 3 itself and the load resulting from the pressure of the air cylinder 52 as a load. When the bonding head 3 goes down and the semiconductor chip 1 contacts the substrate 4, the bonding load is counteracted with the substrate 4 and thus the load detected from the load cell 51 is reduced. Therefore, the load of the bonding head 3 is controlled by using an elevator axis 53 installed to head elevator unit 5 as a load control axis head so as to bring a detected load to a predetermined value.

Incidentally, if the descending of the bonding head 3 is controlled by using such load control, there may occur a problem in which, when the bump 11 of a portion to be bonded is melted during bonding operation of the semiconductor chip 1 to the substrate 4, the bump 11 does not last enduring the bonding load and thus the bonding head 3 comes into descending rapidly, so that the melted bump 11 may be broken and collapsed.

For this reason, a descent stopping mechanism including the stopper 6 and the stopper support 7 is provided. As shown in FIG. 1 and FIG. 3, the stopper 6 is integrally provided to the bonding head 3. On the other hand, the stopper support 7, which supports the stopper 6, is provided independently from the bonding head 3 at a position at which the stopper support 7 is engaged with the stopper 6.

The displacement meter 8 detects a distance between the stopper 6 and the stopper support 7. The displacement meter 8 is suspended above the stopper 6 such that a tip end portion of the displacement meter 8 is allowed to pass through an empty space in the stopper 6 without contacting the stopper 6 so as to detect the tip end of the stopper support 7. Incidentally, a potentiometer may used as the displacement meter 8.

The stopper support 7 is provided with the stopper support elevator unit 9 that lifts up/down the stopper support 7 along the support elevator axis 10 independently from the bonding head 3. Reference numeral M2 refers to an elevator motor of the stopper support elevator unit 9. The support elevator axis 10 becomes a position control axis related to the stopper support 7.

Next, control operations of the distance between the substrate 4 and the semiconductor chip 1 in the flip chip bonding apparatus according to this exemplary embodiment will be described with reference to FIG. 4 to FIG. 7D. The bonding tool 2 is heated to 100° C. with the heating unit incorporated in the bonding head 3, and the semiconductor chip 1 is sucked and held by the bonding tool 2. At this time, 10N as the sum of the load due to weight of the bonding head 3 itself and the load resulting from the pressure of the air cylinder 52 is applied to the load cell 51. Then, the bonding head 3 positioned at a lateral bonding location moves downward, as shown in FIG. 4, with the rotation of the motor M1 provided to the head elevator unit 5 until the semiconductor chip 1 contacts the substrate 4.

When the semiconductor chip 1 contacts the substrate 4, the load detected from the load cell 51 reduces. For example, if 8N of the load is detected from the load cell 51, it is determined that the semiconductor chip 1 contacts the substrate 4. At this time, the distance between the stopper 6 and the stopper support 7 is set to a predetermined distance as shown in FIG. 4 and FIG. 7A. This predetermined distance is an appropriated or desired descending distance (for example, 10 micron) of the bonding head 3 in bonding the semiconductor chip 1 to the substrate 4. That is, when it is determined that the semiconductor chip 1 contacts the substrate 4, the distance between the stopper 6 and the stopper support 7 is set to 10 micron of the predetermined distance.

Subsequently, in order to present a predetermined bonding load and a predetermined bonding temperature to the substrate 4, the bonding tool 2 of the bonding head 3 is heated to a predetermined temperature after the bonding head 3 descends until the load cell 51 detects a predetermined load. Specifically, as the bonding head 3 goes down to apply some load to the substrate 4, the load detected from the load cell 51 reduces gradually from 8N to 5N. At a time where 5N of the load is detected, it is determined that the predetermined bonding load has been applied, and the temperature of the bonding tool 2 increases from 100° C. to 300° C. As a result, before the bump 11 is melted, the bonding head is thermally expanded because of the heating, and thus the stopper 6 moves upward by the thermal expansion extent of the bonding head 3, so that the distance between the stopper 6 and the stopper support 7 becomes larger. For example, as shown in FIG. 5 and FIG. 7B, the distance between the stopper 6 and the stopper support 7 becomes 30 micron.

At this time, it is detected from a signal from the displacement meter 8 that the distance between the stopper 6 and the stopper support 7 becomes 30 micron. In response to such a detection, the stopper support elevator unit 9 controls a height of the stopper support 7 so as to keep the distance between the stopper 6 and the stopper support 7 at the predetermined distance (10 micron), as shown in FIG. 7C, using a signal from the displacement meter 8 until the bump 11 has been melted. That is, the stopper support elevator unit 9 lifts up the stopper support 7 toward the stopper 6 so as to keep the distance between the stopper 6 and the stopper support 7 at the appropriated or desired descending distance (10 micron) of the bonding head 3 until the bump 11 has been melted.

Thereafter, the bump 11 has been melted and thus the bonding head 3 descends rapidly to bring out the engagement between the stopper 6 and the stopper support 7. If the distance between the stopper 6 and the stopper support 7 is detected to be zero or to be a distance equal to or smaller than a predetermined distance, it is determined that the bump 11 has been melted and hence the control operation of the stopper support elevator unit 9 is stopped. When the bonding head 3 descends rapidly because of the melting of the bump 11, the descent height (position) of the bonding head 3 is regulated by engaging the stopper 6 with the stopper support 7 as shown in FIG. 6 and FIG. 7D. That is, the bonding head 3 moves downward by the appropriated or desired descending distance (10 micron) of the bonding head 3, and then the stopper 6 is engaged with the stopper support 7 so that the descent height (position) of the bonding head 3 is regulated. Consequently, the bonding head 3 can be prevented from moving downward by 30 micron and can be prevented from excessively breaking and collapsing the bump 11.

Incidentally, the timing when the control operation of the stopper support elevator unit 9 stops may be decided based on other factors than the distance between the stopper 6 and the stopper support 7. For example, the control operation of the stopper support elevator unit 9 may stop a few second after the temperature of the bonding head 3 has risen; or the control operation of the stopper support elevator unit 9 may stop based on the bonding load detected from the load cell 51.

What is claimed is:

1. A bonding apparatus that is configured to heat and press an electronic part to a substrate via a conductive bump, the bonding apparatus comprising:
a bonding head having a bonding tool for sucking and holding the electronic part;
elevator means lifting up/down the bonding head;
a stopper provided to the bonding head;
a stopper support that regulates a descending height of the bonding head with engagement with the stopper;
distance detection means that detects a distance between the stopper and the stopper support;
stopper support elevator means that lifts up/down the stopper support independently from the bonding head; and
control means that controls the stopper support elevator means,
wherein the control means controls a height of the stopper support so as to keep the distance between the stopper and the stopper support at a predetermined distance by using a signal from the distance detection means until the bump is melted in heating and pressing the electronic part to the substrate.
